(19) United States
(12) Patent Application Publication
(10) Pub. No.: US 2016/0308402 A1
(43) Pub. Date: Oct. 20, 2016

(54) Electromagnetic Energy Harvesting Using Complementary Split-Ring Resonators

(71) Applicants: Babak Alavikia, Waterloo (CA); Thamer Almoneef, Kitchener (CA); Omar M. Ramahi, Waterloo (CA)

(72) Inventors: Babak Alavikia, Waterloo (CA); Thamer Almoneef, Kitchener (CA); Omar M. Ramahi, Waterloo (CA)

(21) Appl. No.: 14/690,784

(22) Filed: Apr. 20, 2015

(51) Int. Cl. H02J 50/27; H02J 50/40; H01Q 21/06; H01Q 9/04; H01Q 1/38

(52) U.S. Cl. CPC H02J 50/27; H01Q 9/0407; H01Q 1/38; H01Q 21/065; H02J 50/40

(57) ABSTRACT

The current invention provides Ground-backed Complementary Split Ring Resonators (G-CSRR) as a new class of energy collectors and transmitters for electromagnetic energy harvesting in general and wireless power transfer applications in particular. The G-CSRR structure has low profile, low fabrication cost, efficient for wide range of illumination angles and can be placed on metallic surfaces.

### CROSS-REFERENCE TO RELATED APPLICATIONS

This invention claims priority to pending U.S. Provisional Patent Application No. 61/923,822, entitled Electromagnetic Energy Harvesting using Complementary Split-Ring Resonators, filed on Jan. 6, 2014, the contents of which are herein incorporated by reference.

### FIELD OF THE INVENTION

This invention relates generally to electromagnetic energy harvesting systems, and particularly to wireless power transfer systems and rectenna systems operating at both the microwave and terahertz frequency regimes. In addition, the invention relates to applications where electric energy is needed such as Space Solar Power (SSP) systems, Radio Frequency Identification (RFID) systems, charging batteries, etc.

### BACKGROUND OF THE INVENTION

In every minute enough sunlight reaches the earth's surface to meet the world's energy demand for an entire year. Due to this enormous amount of electromagnetic energy emitted by the sun, researchers have focused on developing systems that can harness solar energy. The electromagnetic energy emitted by the sun spans a bandwidth of wavelengths ranging between 0.1-4 μm from which 7% is in the form of ultraviolet (0.1-0.4 μm), 44% lies in the visible light band (0.4-0.71 μm) and the rest, is concentrated at the near- and far-infrared region (0.71-4 μm). The percentages of the solar energy distribution vary slightly close to the ground levels [Pidwirny. M. (2006). “The Nature of Radiation”. Fundamentals of Physical Geography, 2nd Edition]. Solar cells are a common type of technology that makes use of solar energy, which is based on the photovoltaic effect that converts photon energy to DC power by using semiconductor materials. Photovoltaics in most cases are capable of harvesting a limited band of the solar spectrum, 0.4-0.71 μm. Additionally, their performance is limited to the type of semiconductor material used. Generally, the output electrical energy of solar panels is between 11-27% of the radiant energy [National Energy Education Development Project, Solar, secondary energy infobook, National Energy Education Development Project, Manassas. P42, (2012)]. This percentage is greatly dependent on its installment location and is affected by weather conditions, such as dusty climates. Moreover, photovoltaics depend on direct sunlight illuminations and therefore it cannot function at night time when the sun is down. In addition to the energy radiated by the sun, there is an abundance of thermal infrared radiation on the surface of the earth due to the cooling process of the earth at night time. If used effectively, this source of power along with the great amount of solar energy untapped by photovoltaics, could provide clean and sufficient amount of energy that could meet the globe's growing energy demand.

Another technology for harvesting the energy emitted by the sun is possible by using nano-antennas that can capture the electromagnetic solar energy then rectify the energy using fast switching tunneling diodes. This technology is commonly referred to in the literature, as a rectenna (rectifying antenna) system which was proposed in the 1970's by Bailey [t. L. Bailey, Journal of Engineering for Power, Vol 73, (1972)] and has since then become an intriguing topic for researchers. If properly designed, one of the advantages of this method is that, not only can it harvest the solar energy but also it can be applied to recycle the available electromagnetic energy that is continuously around us due to communication applications or many others operating at the microwave spectrum. A general structure of a basic rectenna system consists of five main elements as shown in FIG. 1. The electromagnetic energy is captured using a receiving antenna operating at a specific frequency or over a bandwidth of frequencies. A filter is connected to the antenna to suppress unwanted harmonics caused be the nonlinear behavior of the diode and match the antenna impedance to that of the diode. After the AC power channels from the antenna through the filter, a Schottky or MIM diode is used to rectify or convert the collected AC power to DC. An additional low-pass filter is connected after the diode for eliminating any remaining AC components before reaching the load.

In most of the existing rectenna systems, classical antennas such as microstrip dipole antenna [T. W. Yoo et al., Electronics Letter. 27, 2117 (1991)], circular microstrip patch antenna [N. Shinohara et al., Microwave Theory and Techniques. IEEE Transactions on 46, 261 (1998)], and bow-tie retrodirective rectenna [Y. J. Ren et al., Electronics Letter 42, 1 (2006)] are used as the main source for collecting the electromagnetic energy. The power level harnessed by rectenna systems is in the range of milli-Watt and for this system to become more effective, the collector used should be highly efficient. Additionally, in the energy harvesting applications where a large amount of power is required, the energy collectors are used in array form to increase the amount of the harnessed power (refer to FIG. 2). However, the total footprint of the array is constrained by physical area of the device or land. Therefore, the electrical size (ratio of physical size to the operating wavelength) and the total number of the collectors that can be grouped per footprint affect the efficiency of the power harvesting significantly. Relatively large dimension of classical antennas which is comparable to a half free-space wavelength as well as large required spacing between the antennas to avoid destructive mutual coupling between the array elements impose certain limitation on using classical antennas in array form as energy collectors in the rectenna systems.

Consequently, because of the low efficiency of current rectenna systems, an improvement in the primary elements responsible for electromagnetic energy collection or electromagnetic energy harvesting is needed. Furthermore, energy collectors with smaller electrical size comparable to the existing collectors used in the art (such as classical antennas) are needed to utilize in applications where the size of the system is critical.

### SUMMARY OF THE INVENTION

The current invention provides Ground-backed Complementary Split Ring Resonators (G-CSRR) as a new class of energy collectors and transmitters for electromagnetic energy harvesting in general and wireless power transfer applications in particular.

The Ground-backed Complementary Split Ring Resonators are categorized as electrically small resonators where their size are much smaller than the operating wavelength. The resonance phenomena in the G-CSRR structures is highly similar to an RLC circuit where a capacitor is connected to an inductor. By the resonance of the such a RLC circuit, it is implied that an electric current can be sustained within the circuit without any active external excitation or source. Of course, energy has to be transferred to the RLC circuit somehow (inductively or by other means) in the first place. Thus it is critical to realize that the resonance phenomenon of the G-CSRR structure is fundamentally different from the resonance of the classical antennas such as half-wavelength dipole antenna, wide-band log-periodic antennas, microstrip patch antennas, or other type of resonant antennas that have dimensions comparable or close to the wavelength corresponding to the operational frequency.

The G-CSRR structures have distinct advantages in comparison to the energy collectors in the current art (i.e., classical antennas), most important of which is significant power conversion efficiency enhancement. Additionally, the G-CSRR structures provide wider bandwidth in comparison to the classical antennas. Another important advantage of the presented invention is possibility of close placement of the G-CSRR elements in array form at distances comparable to few percents of the resonance wavelength and thus possibility of highly miniaturization of the total footprint of the G-CSRR array while maintaining the enhanced power conversion efficiency of the structure. The ability to position the G-CSRR structures over conducting surfaces and thus have them completely shielded from any wireless devices contained within the surface is another distinct and important advantage of the current invention.

The description of the invention section shall explain in details the full embodiment including the working mechanism of the G-CSRR structure including the working mechanism of the harvesting collector along with numerical simulations.

### BRIEF DESCRIPTION OF THE DRAWINGS

FIG. 1 is useful to illustrate a block diagram for a generic rectenna system using antenna modules as primary energy collectors;

FIG. 2 schematically illustrates exemplary arrays of printed dipoles, printed bow-tie antennas, and microstrip patch antennas as classical antenna modules used in rectenna systems (Prior Art);

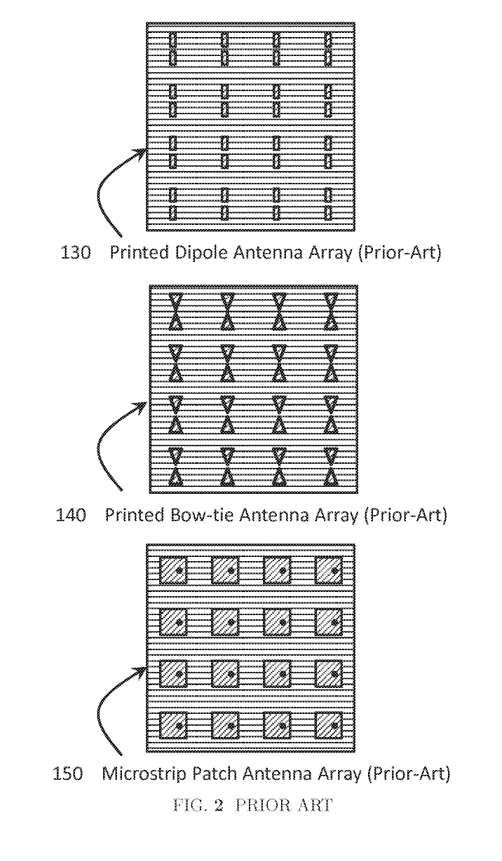

FIG. 3 schematically illustrates an exemplary G-CSRR unit-cell of the invention;

FIG. 4 schematically illustrates top views of square G-CSRR unit-cell examples comprising square CSRR patches with various etched loop types;

FIG. 5 schematically illustrates top views of hexagonal G-CSRR unit-cell examples comprising CSRR patches with various geometries and etched loop types;

FIG. 6 schematically illustrates bottom views of G-CSRR unit-cell examples with various geometries of ground planes;

FIG. 7 schematically illustrates an isometric view of an exemplary G-CSRR unit-cell of the invention;

FIG. 8 schematically illustrates a top view of an exemplary G-CSRR unit-cell of the invention;

FIG. 9 schematically illustrates a bottom view of an exemplary G-CSRR unit-cell of the invention;

FIG. 10 schematically illustrates array of G-CSRR structures with plurality of elements with various geometries;

FIG. 11 schematically illustrates array of G-CSRR structures with plurality of elements in one-, two-, or three-dimension(s);

FIG. 12 schematically illustrates periodic and nearly periodic array of G-CSRR structures with plurality of elements;

FIG. 13 schematically illustrates symmetric and asymmetric array of G-CSRR structures with plurality of elements;

FIG. 14 illustrates an equivalent circuit model of exemplary G-CSRR unit-cell of the invention operating in transmission mode;

FIG. 15 is useful to illustrate properties of exemplary G-CSRR unit-cell of the invention;

FIG. 16 is useful to illustrate properties of exemplary G-CSRR unit-cell of the invention;

FIG. 17 is useful to illustrate properties of exemplary G-CSRR unit-cell of the invention;

FIG. 18 illustrates two identical footprints occupying a 4×4 patch antenna array and 8×8 CSRR array;

FIG. 19 illustrates the simulation setup of exemplary infinite array of G-CSRR structure of the invention and microstrip patch antenna array;

FIG. 20 illustrates an equivalent circuit model of exemplary G-CSRR unit-cell of the invention operating in receiving mode:

FIG. 21 illustrates properties of the exemplary G-CSRR unit-cell of the invention;

FIG. 22 illustrates properties of the fabricated exemplary G-CSRR array of the invention.

### DRAWINGS

### Reference Numerals

10 G-CSRR unit-cell
20 CSRR Patch(s)
30 Dielectric Substrate
40 Etched Loop(s)
50 Bridge(s)
60 Via Interconnect
70 Ground Plane
80 Etched Loop on Ground Plane
90 G-CSRR Array(s)
100 Protective Superstrate Coating Layer(s)
110 Periodic Boundary Condition
120 Floquet Port
130 Printed Dipole Antenna Array (Prior-Art.)
140 Printed Bow-tie Antenna Array (Prior-Art)
150 Microstrip Patch Antenna Array (Prior-Art)
160 Microstrip Patch Antenna Unit-Cell (Prior-Art)
170 Power Line

### DETAILED DESCRIPTION OF THE INVENTION

The invention describes an electromagnetic energy collector based on Complementary Split Ring Resonators (CSRRs). Since there can be a variety of permutations and embodiments of the present invention, certain embodiments will be illustrated and described with reference to the accompanying drawings. This, however, by no means restricts the present invention to certain embodiments, and shall be construed as including all permutations, equivalents, and substitutes covered by the spirit and scope of the present invention.

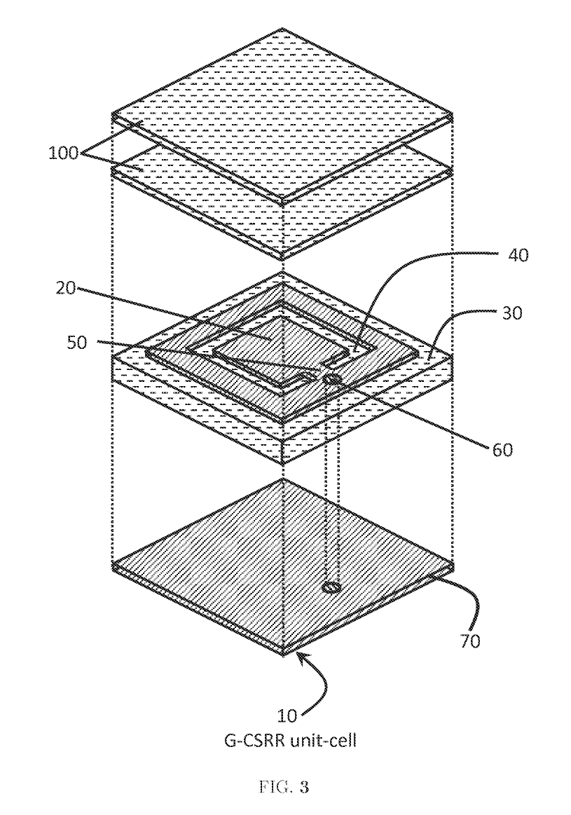

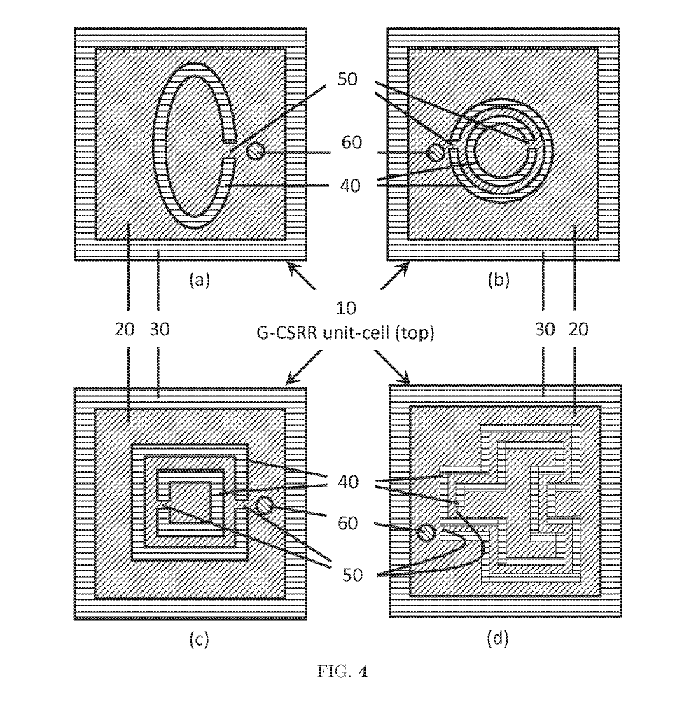

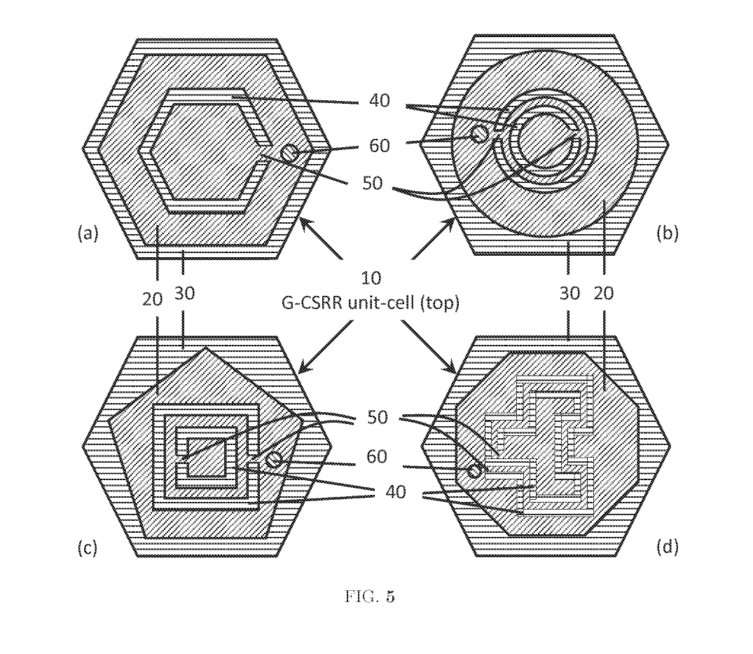

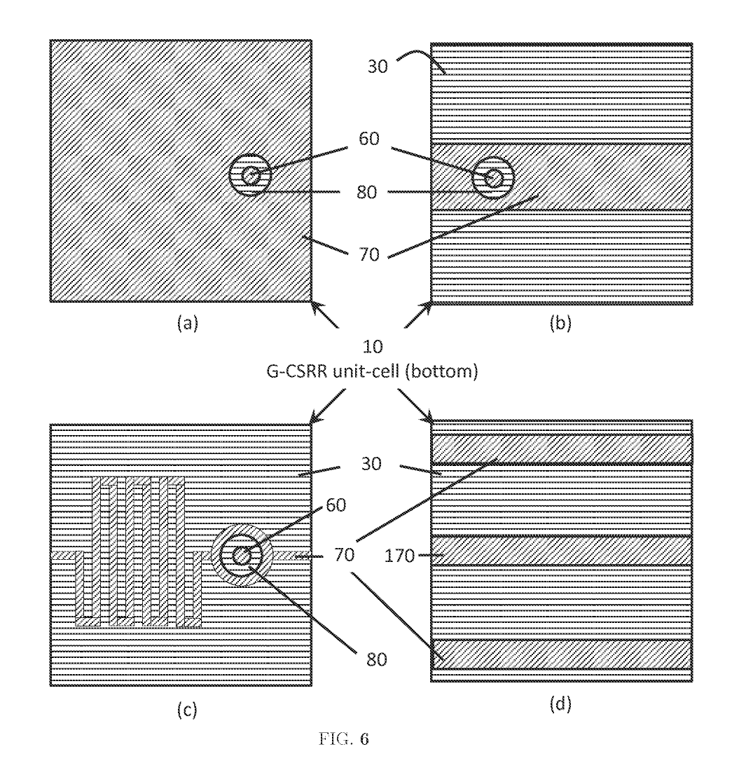

A CSRR structure comprising metallic (conducting) CSRR Patch(es) 20 deposited or printed on a non-conductive medium host herein referred as Dielectric Substrate 30 is shown in FIG. 3. The CSRR Patch(es) 20 is a planar conducting structure with a center island separated from the surrounding planes by plurality of broken Etched Loop(s) 40. The center conducting island is connected to its surroundings through narrow Bridge(s) 50. The CSRR Patch(es) 20 can take various geometries including but not limited to square, rectangular, hexagonal, circular, pentagonal, octagonal, etc (refer to FIG. 4 and FIG. 5). Furthermore, The CSRR Patch(es) 20 can comprise plurality of Etched Loop(s) 40 with various geometries including but not limited to oval, circular, rectangular, fractional Hilbert curves, hexagonal, etc (refer to FIG. 4 and FIG. 5). The Dielectric Substrate 30 can also take various cross-section geometries including but not limited to square, rectangular, hexagonal, etc (refer to FIG. 4 and FIG. 5). The Dielectric Substrate 30 with hexagonal cross-section is useful in forming arrays of CSRR structures with specific configurations. The CSRR Patch(es) 20 can be covered with plurality of non-conductive Protective Superstrate Coating Layer(s) 100 as shown in FIG. 3 to be protected from physical or chemical damages. At certain frequency, the CSRR structure resonates if excited with an external electric field having polarization predominant in the direction perpendicular to the surface of the CSRR Patch(es) 20. Similar to RLC circuits, the resonance frequency depends on the inductance associated with the length of the electric current path on the Bridge(s) 50 and the capacitance associated with the size of the Etched Loop(s) 40 between the center and surrounding conductors of the CSRR Patch(es) 20. The resonance phenomena in the CSRR structure is also highly similar to the RLC circuit such that at resonance the stored energy within the CSRR structure oscillates between the electric and magnetic fields and leads to a build up of relatively high electric currents on the Bridge(s) 50. The strength of resonance, which is indicative of the intensity of the stored electromagnetic energy within the resonator, depends on the incident angle and polarization of the excitation wave. The maximum resonance strength is expected for grazing incident waves with the electric field vector perpendicular to the surface of the CSRR Patch(es) 20. This polarization (grazing incidence) is impractical if the CSRR structure was placed on a low-profile platform perpendicular to the zenith angle. By placing a Ground Plane 70 underneath the Dielectric Substrate 30 such that the Dielectric Substrate 30 is kept electrically very thin, the dominant electric field vector within the Dielectric Substrate 30 is then forced to be perpendicular to the Ground Plane 70 under practically any polarization (with different resonance intensity depending on the angle of incidence). The CSRR structure with Ground Plane 70 backing, henceforth referred to as G-CSRR structure where a G-CSRR Unit-Cell 10 of which is shown in FIG. 3. The Ground Plane 70 can take geometries either similar to those of the Dielectric Substrate 30 or various geometries including but not limited to the microstrip lines and meander lines to fully or partially cover the underneath of the Dielectric Substrate 30 (refer to FIG. 6). To collect and channel the electric current developed on the Bridge(s) 50 of the CSRR Patch(es) 20 into a resistive load, a Via Interconnect 60 passing through the Dielectric Substrate 30 is added to the G-CSRR Unit-Cell 10. The Via Interconnect 60 is connected to the part of the Ground Plane 70 which is separated from the rest of the Ground Plane 70 by a Ground Plane Etched Loop 80 forming input terminals of the G-CSRR structure. As another embodiment of the current invention, the developed electric current on the Bridge(s) 50 can also be routed to the transmission paths through the modal coupling between the CSRR Patch(es) 20 and the Power Line 170 (refer to FIG. 6(d)).

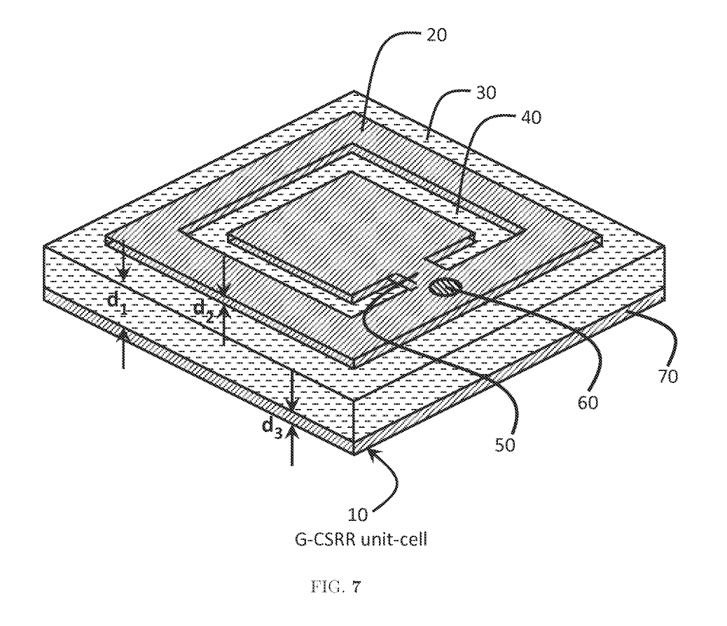

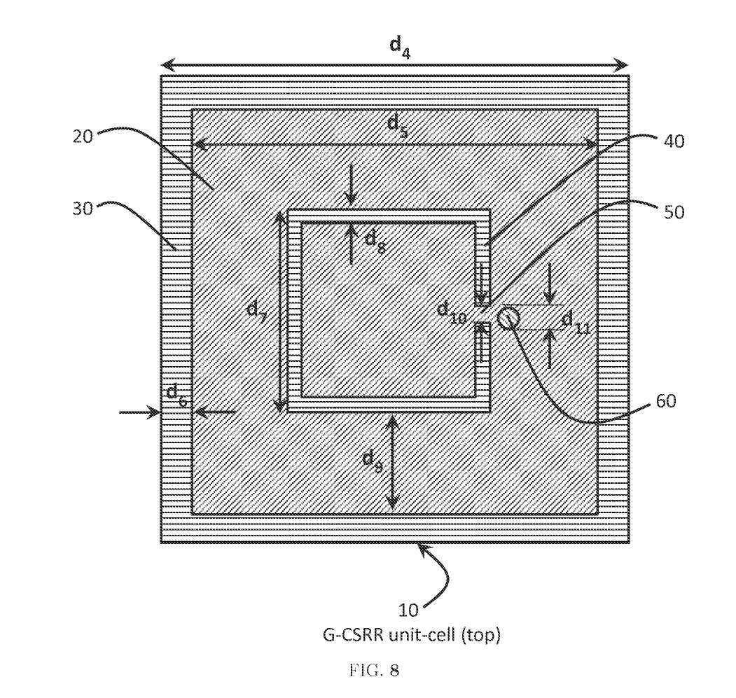

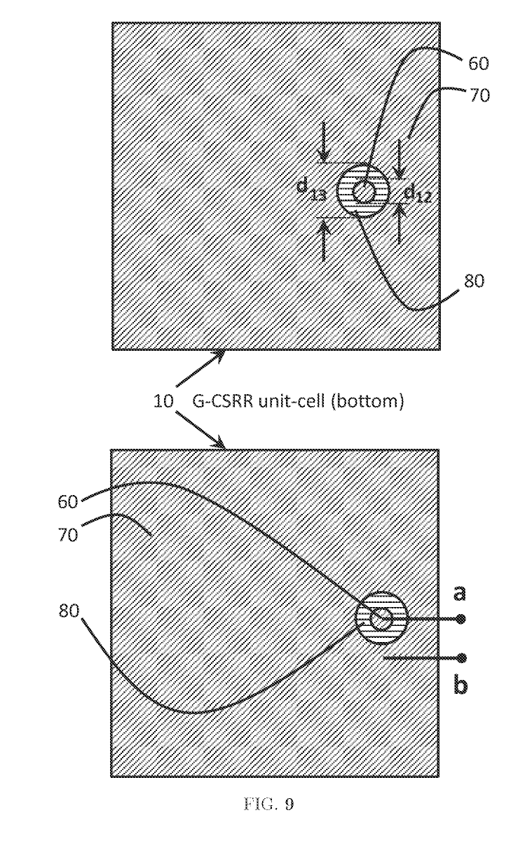

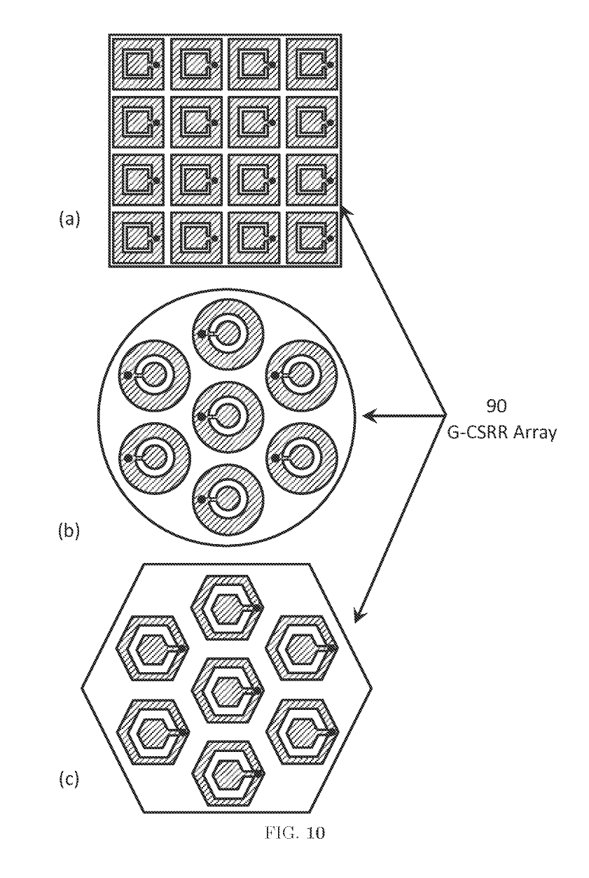

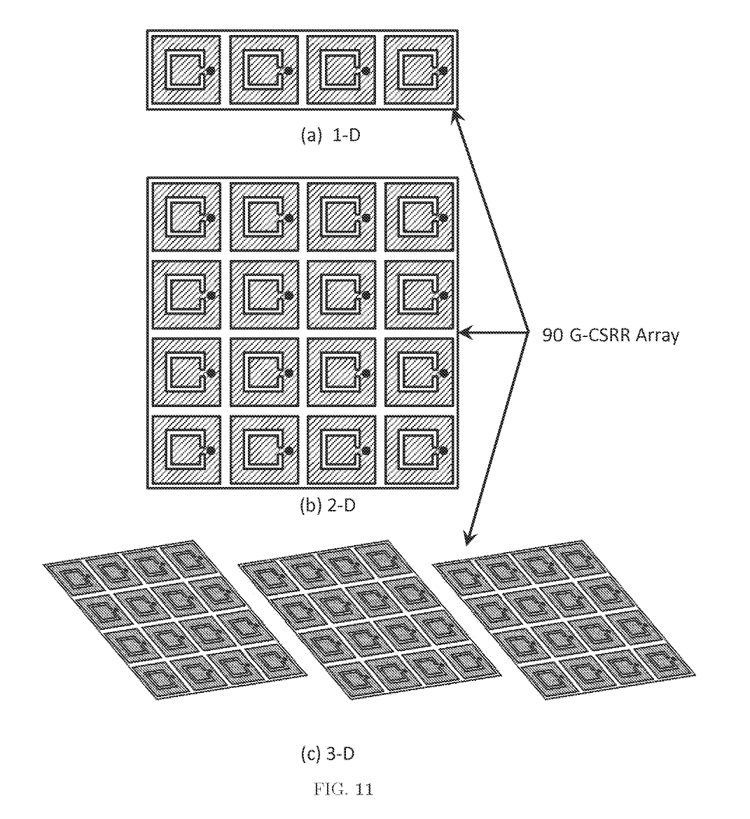

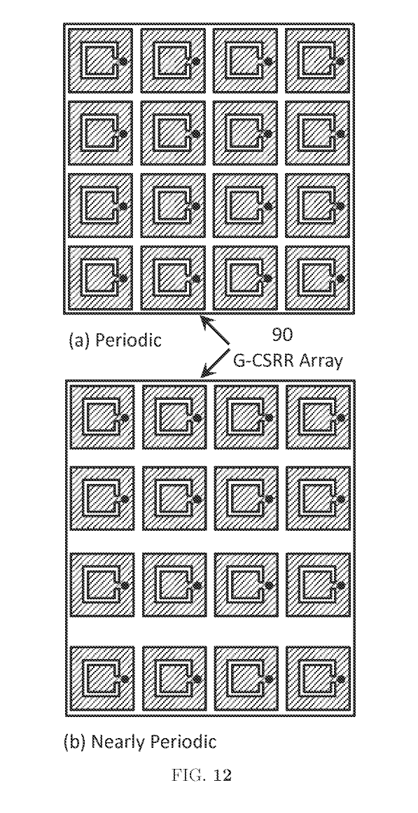

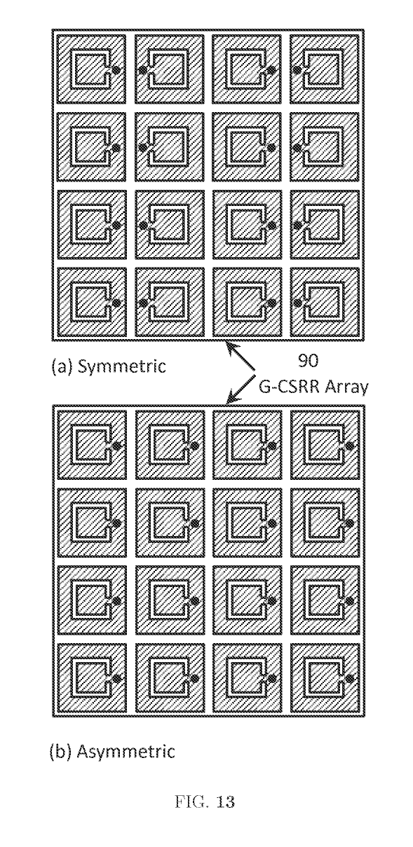

Without loss of generality, we presently contemplate for this embodiment a G-CSRR Unit-Cell 10 as a part of an infinite two-dimensional array comprising a thin square copper CSRR Patch(es) 20 with a single square Etched Loop(s) 40 printed over a thick square Rogers Duroid RT5880 Dielectric Substrate 30 which its underneath is fully covered with a thin copper Ground Plane 70 (refer to FIG. 7). The G-CSRR Unit-Cell 10 of this embodiment, is not covered with Protective Superstrate Coating Layer(s) 100. The G-CSRR Unit-Cell 10 was designed using commercial electromagnetic full-wave simulator ANSYS HFSS to resonate at around 5.55 GHz. The thickness of the Dielectric Substrate 30, CSRR Patch(es) 20, and the Ground Plane 70 were read as d₁=0.79 mm, d₂=0.030 mm, and d₃=0.030 mm, respectively. Referring to FIG. 8, the size of the square G-CSRR Unit-Cell 10 was set as d₄=18.5 mm. The square CSRR Patch(es) 20 with dimension of d₅=16 mm was placed at distance of d₆=1.25 mm far from the edges of the G-CSRR Unit-Cell 10. A single square Etched Loop(s) 40 with length of d₇=8 mm and width of d₈=0.55 mm was etched from the CSRR Patch(es) 20 out such that the Etched Loop(s) 40 was located at distance of d₉=4 mm far from the edges of the CSRR Patch(es) 20. The width of the Bridge(s) 50 was read as d₁₀=0.4 mm. The Via Interconnect 60 with diameter of d₁₁=0.5 mm was placed at distance of 4.4 mm far from the center of the G-CSRR Unit-Cell 10. The circular Ground Plane Etched Loop 80 with inner and outer radii of d₁₂=0.5 mm and d₁₃=1 mm was etched out from the Ground Plane 70 to form the input terminals of the structure (refer to FIG. 9). We contemplate the G-CSRR Unit-Cell 10 for this embodiment comprising the aforementioned materials, geometries, and dimensions to resonate at 5.55 GHz. However, the G-CSRR Unit-Cell 10 can take different materials, geometries, and dimensions to resonate at different specific frequencies. Furthermore, We contemplate an infinite two-dimensional square array of G-CSRR Unit-Cell 10 for this embodiment. G-CSRR. Array(s) 90 with plurality of elements in one-, two-, or three-dimension(s) with plurality of footprint geometries such as square, rectangular, circular, polygonal, etc, are also possible (refer to FIG. 10 and FIG. 11). Furthermore, a plurality of G-CSRR Unit-Cell 10 can form periodic or nearly periodic G-CSRR Array(s) 90 (refer to FIG. 12). Also, referring to FIG. 13, the elements of the G-CSRR Array(s) 90 can be positioned symmetrically or asymmetrically.

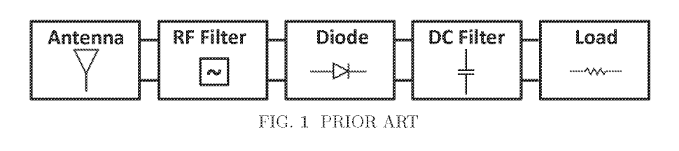

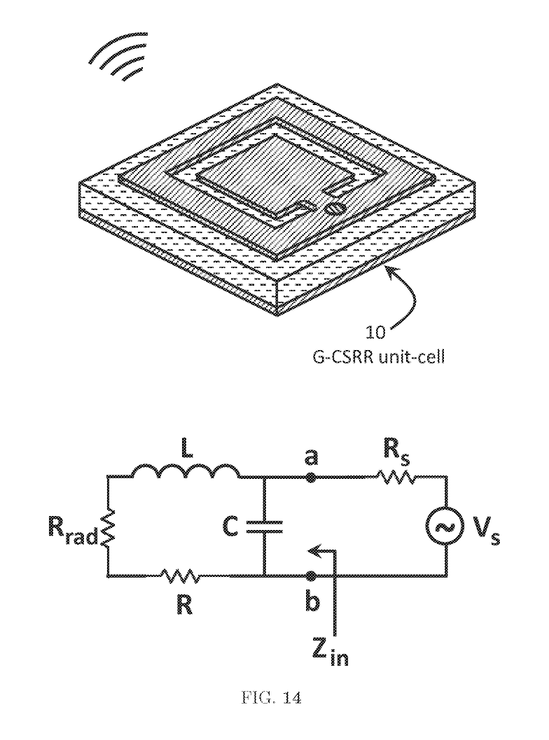

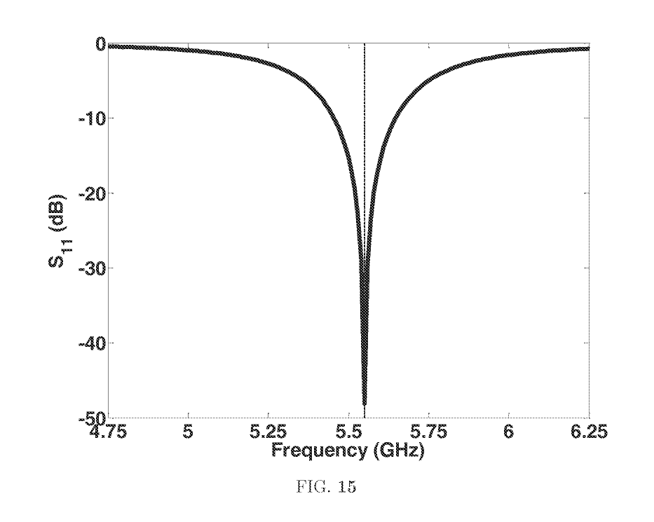

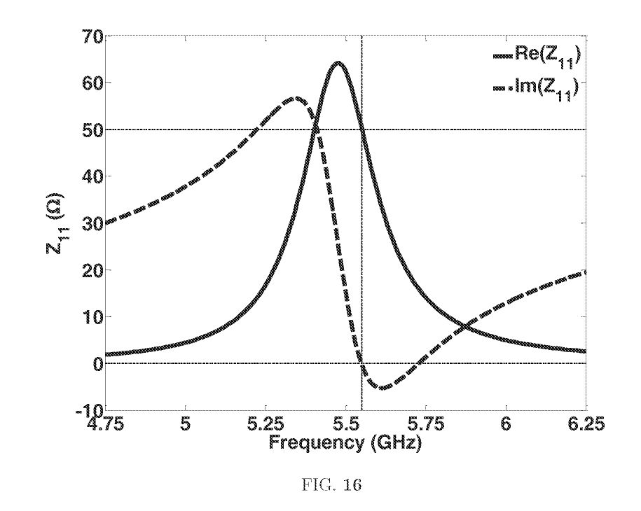

In a practical energy harvesting system, a full rectification circuitry including matching networks, diodes, and load should be placed at the input terminals of an energy collector to convert AC power to DC (refer to FIG. 1). Designing such a rectification circuit critically depends on the operation frequency and the input impedance of the energy collector which in turn depends on its size and topology. To determine the input impedance of the exemplified G-CSRR Unit-Cell 10 as a part of an infinite two-dimensional G-CSRR Array(s) 90, the G-CSRR Unit-Cell 10 was operated in the transmission mode by placing a 50Ω lumped voltage source at the input terminals of each G-CSRR Unit-Cell 10 between the Via Interconnect 60 and the Ground Plane 70 in the electromagnetic simulator (refer to FIG. 9, the input terminals are labeled by letters a and b). FIG. 14 illustrates an equivalent circuit model of a G-CSRR Unit-Cell 10 operating in the transmission mode. A G-CSRR Unit-Cell 10 can be realized as a simple RLC circuit where the CSRR Patch(es) 20, the Bridge(s) 50, and the Via Interconnect 60 mainly contribute to the inductance, L. Furthermore, the size of the Etched Loop(s) 40 and the separation distance between the CSRR Patch(es) 20 and the Ground Plane 70 (thickness of the Dielectric Substrate 30) contribute to the capacitance, C. Hence, by varying the dimensions of the design, one can design a. G-CSRR Unit-Cell 10 to resonate at specified resonance frequency. The ohmic loss in the conductors and the dielectric losses contribute to the resistance, R. FIG. 14 also illustrates the Thevenin equivalent of the voltage source which is connected to the input terminals of the G-CSRR Unit-Cell 10. FIG. 15 illustrates the calculated magnitude of the return loss (S₁₁) of the voltage source connected to the exemplified G-CSRR Unit-Cell 10. At the frequency of 5.55 GHz, a dramatic drop in S₁₁ is observed which indicates transfer of the 99.9998% of the generated power by the voltage source to the G-CSRR Unit-Cell 10. The calculated real and imaginary parts of the input impedance (Z₁₁) of the exemplified G-CSRR Unit-Cell 10 are illustrated in FIG. 16. At the resonance frequency of 5.55 GHz, the imaginary part of the input impedance vanishes where the real part of the input impedance is read as 50Ω which is matched to the voltage source.

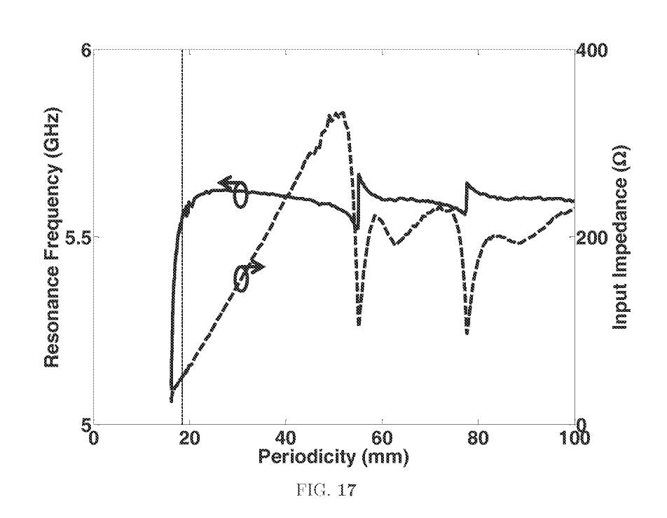

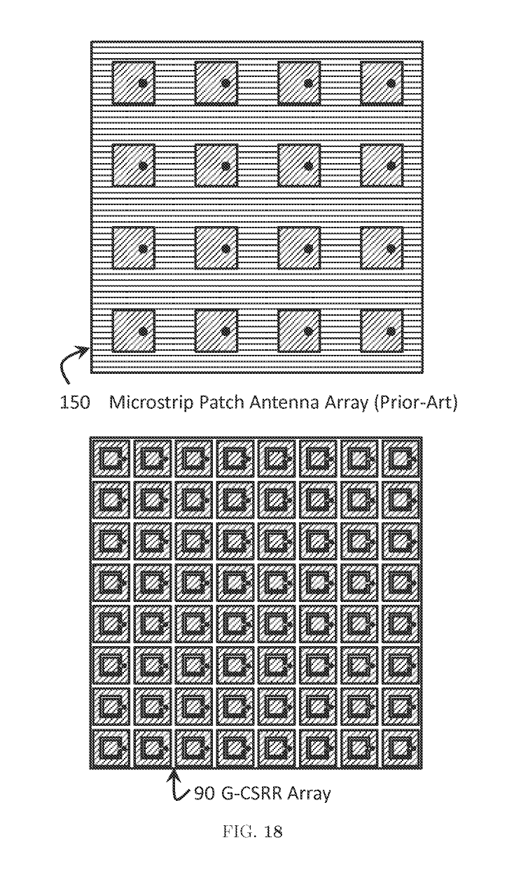

FIG. 17 represents calculated resonance frequency and input impedance of the exemplified G-CSRR Unit-Cell 10 as a part of an infinite G-CSRR Array(s) 90 for various values of the unit-cell sizes or array periodicity (refer to d₄ in FIG. 8). The G-CSRR Unit-Cell 10 resonates at the array periodicity values greater than d₄=16.21 mm. In other words, the required minimum separation distance between the adjacent exemplified G-CSRR Patch(es) 20 to achieve resonance is only 0.21 mm or approximately 0.003λ where λ is the resonance wavelength. Notice that the required minimum separation distance between the adjacent elements in array of classical antennas (prior arts) is about 0.5λ to avoid destructive mutual coupling between the elements. Such very small separation distance between the adjacent CSRR Patch(es) 20 in the G-CSRR Array(s) 90 in comparison with the classical antennas provides possibility of highly miniaturization of the total footprint of the G-CSRR Array(s) 90. FIG. 18 illustrates a comparison between number of elements per footprint where 64 of exemplified G-CSRR Unit-Cell 10 occupy the same footprint as of 16 microstrip patch antennas resonating at the same frequency. Referring to FIG. 17, for the small values of the periodicities, the resonance frequency of the G-CSRR Unit-Cell 10 increases as the periodicity of the array d₄ and thus the distance between the adjacent CSRR Patch(es) 20 increases. This can be attributed to the decrement in the capacitance between the adjacent CSRR Patch(es) 20. Furthermore, for small separation distances between the CSRR Patch(es) 20 where each patch is located in the near-field region of the adjacent CSRR Patch(es) 20, the input impedance of the G-CSRR Unit-Cell 10 increases monotonically as the periodicity of the array increases. This unique property of the G-CSRR Array(s) 90 provides possibility of predicting the input impedance of the G-CSRR Unit-Cell 10 in terms of periodicity of the array. In our exemplified design, we found out that the periodicity of d₄=18.5 mm is associated with the input impedance of 50Ω for each G-CSRR Unit-Cell 10 to be matched with voltage source. The radiation efficiency of the exemplified G-CSRR Array(s) 90 resonating at 5.55 GHz was calculated through numerical analysis as 93%.

In developing a new electromagnetic energy harvesting platform, The free-space electromagnetic wave to AC power conversion efficiency (for sake of brevity we use power conversion efficiency herein) is a critical parameter. It is important to note that despite the applicability of the reciprocity theorem to receive-transmit antenna pair, the definition of the power conversion efficiency in energy harvesting applications for an energy collector (such as a classical antenna) operating in the receiving mode is different from the radiation efficiency of such a collector operating in the transmission mode. The radiation efficiency in the transmission mode is simply defined as the ratio of the radiated power to the power accepted at the input terminals of the radiator. In the receiving mode, the power conversion efficiency is defined as the ratio of the power received by an energy collector to the energy available at its physical footprint [B. Alavikia. et al., Applied Physics Letters, 104, 163903-1-4 (2014)]. For a single or a finite array of energy collectors with few elements, the physical footprint of the collectors may be much smaller than their radiation apertures resulting in the power conversion efficiency of more than unity. To demonstrate the power conversion efficiency of an energy collector in a consistent way, the physical footprint of the collector must be set equal to its radiation aperture where the collector is treated as an element in an infinite array. In such a scenario, the physical footprint and the radiation aperture of each collector become almost identical to the physical area of each unit-cell in the array.

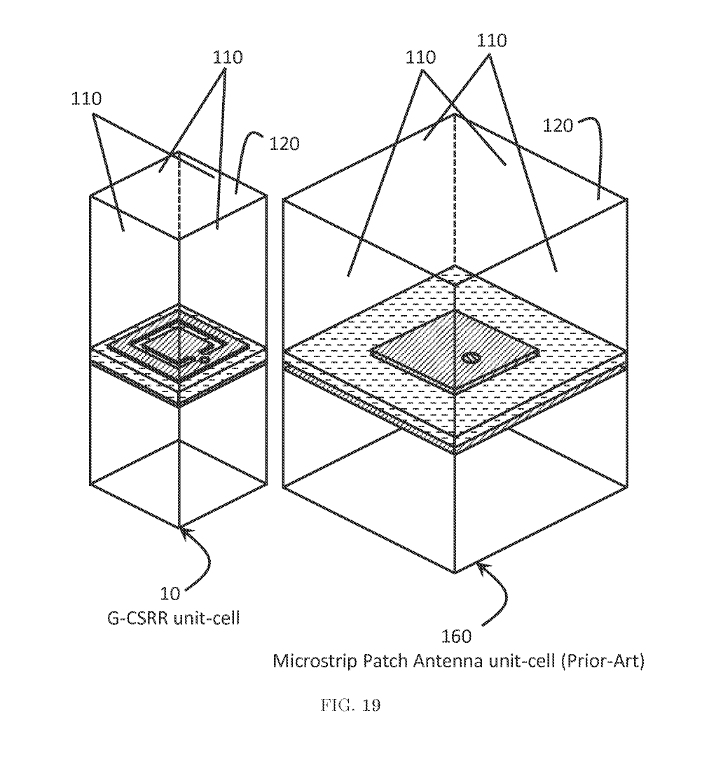

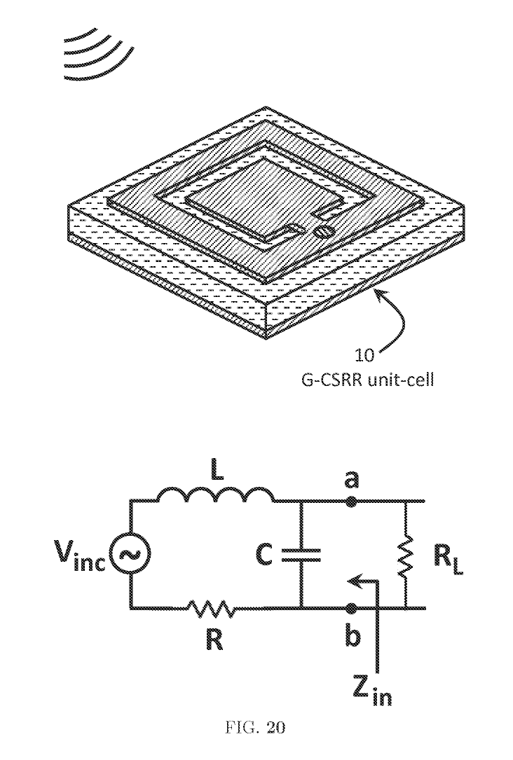

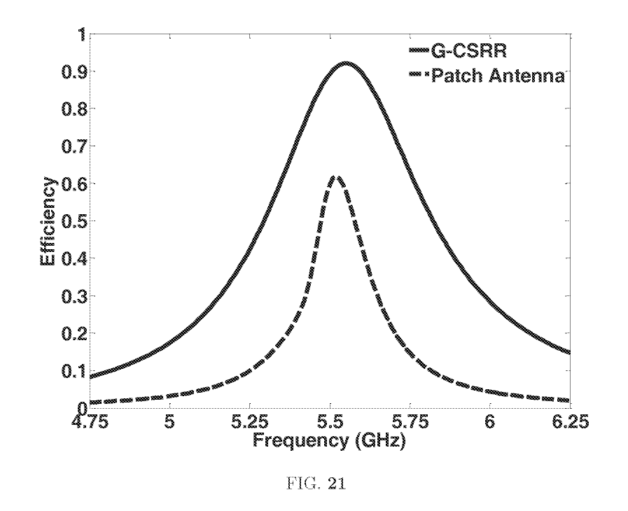

To demonstrate significance of the power conversion efficiency of the exemplified G-CSRR Unit-Cell 10 as a part, of an infinite G-CSRR Array(s) 90, comparison through numerical analysis was made between the exemplified G-CSRR Array(s) 90 and designed infinite two-dimensional Microstrip Patch Antenna Array (Prior-Art) 150 both operating in the receiving mode (refer to FIG. 19). A Microstrip Patch Antenna Unit-Cell (Prior-Art) 160 was designed using the same material used in designing G-CSRR Unit-Cell 10. The size of the square patches and the periodicity of the Microstrip Patch Antenna Array (Prior-Art) 150 were optimized as 16.7 mm, and 34.92 mm, respectively, to obtain maximum power conversion efficiency while minimizing the footprint of the unit-cell. Each microstrip patch antenna was terminated by a coaxial line having an input impedance of 50Ω. The optimal position of the probe feed for each patch is 2.5 mm off from the center of the patch. In the numerical simulator, the Periodic Boundary Condition 110 was applied to the lateral walls of the unit-cells of both structures to numerically realize the infinite arrays. The unit-cells were excited by Floquet Port 120 at the top boundaries generating incident plane waves propagating in direction normal to the surface of arrays such that providing total power of 1 W available at the footprint of the unit-cells (refer to FIG. 19). In order to calculate the received power by the energy collectors through the electromagnetic simulator, the (G-CSRR structure and the patch antenna were terminated by a load equal to their input impedances (50Ω) to ensure maximum power delivery to the loads. FIG. 20 illustrates an equivalent circuit model of the G-CSRR Unit-Cell 10 operating in the receiving mode. A voltage source V_{inc} mimicking the incident electromagnetic wave is connected to the RLC equivalent circuit of G-CSRR Unit-Cell 10 in series. Furthermore, a resistor R_{L} is placed at the input terminals of the G-CSRR Unit-Cell 10 to mimic the resistive load. FIG. 21 illustrates the numerically calculated power conversion efficiency of the exemplified G-CSRR Array(s) 90 compared to the Microstrip Patch Antenna Array (Prior-Art) 150. At the resonance frequency of the G-CSRR Array(s) 90, we observed significant improvement of about 48% in power conversion efficiency compared to the Microstrip Patch Antenna Array (Prior-Art) 150. Furthermore, the bandwidth of the exemplified G-CSRR Array(s) 90 is significantly wider than that of the Microstrip Patch Antenna Array (Prior-Art) 150. More specifically, the G-CSRR Array(s) 90 resulted in half-power bandwidth (HPBW) of 575 MHz while the Microstrip Patch Antenna Array (Prior-Art) 150 resulted in HPBW of only 217 MHz. It is important to note that strong coupling interactions between the adjacent elements of the G-CSRR. Array(s) 90 exist since the CSRR Patch(es) 20 are separated by a distance of only 0.067λ. Notice that the separation distance between the Microstrip Patch Antenna Unit-Cell (Prior-Art) 160 is about 0.495λ to achieve power conversion efficiency of 62%.

To validate the significance of the power conversion efficiency of the G-CSRR Array(s) 90, we fabricated an 11×11 array of exemplified G-CSRR Unit-Cell 10 and a 5×5 Microstrip Patch Antenna Array (Prior-Art) 150 using identical material and design recipe to the designed unit-cells used in the simulations above. To compare the power conversion efficiency of the fabricated G-CSRR Array(s) 90 with the Microstrip Patch Antenna. Array (Prior-Art) 150 we measured the delivered power to the load of the unit-cell located at the center of each array. Notice that all the other unit-cells in both arrays were terminated by a load equal to their input impedances (50Ω) to ensure maximum power delivery to the loads.

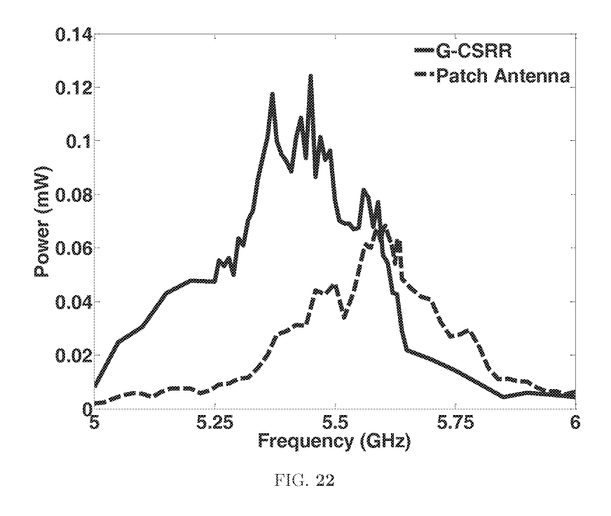

FIG. 22 represents measured delivered power to the load of the aforementioned central unit-cells of the both arrays. The fabricated G-CSRR Array(s) 90 resonates at around approximately 5.45 GHz with maximum received power of approximately 0.124 mW at the input terminals of the central G-CSRR Unit-Cell 10 which is almost twice of the 0.068 mW received power at the input terminals of the central Microstrip Patch Antenna Unit-Cell (Prior-Art) 160. It is important to note that regardless of typical power loss in the connectors, source antenna, and the power sensor, both G-CSRR Array(s) 90 and the Microstrip Patch Antenna Array (Prior-Art) 150 were exposed to the same level of incident power. Thus, the measured power shown in FIG. 22 demonstrates the viability of G-CSRR Array(s) 90 with significant power conversion efficiency improvement in comparison to the Microstrip Patch Antenna. Array (Prior-Art) 150. We note that the measured resonance frequency for the experimental G-CSRR Array(s) 90 was shifted approximately 0.1 GHz from the design due to typical fabrication tolerances as well as truncating an infinite array to an 11×11 array.

What is claimed is:

1. An electromagnetic energy receiving and transmitting device comprising at least one unit-cell of electrically small resonators.

2. The device of claim 1 wherein said unit-cells of electrically small resonators operate at the microwave, millimeter, terahertz, infrared, or visible frequency regime.

3. The device of claim 1 wherein said unit-cells of electrically small resonators are designed to operate at predetermined range of frequencies.

4. The device of claim 1 wherein a plurality of ensembles of said unit-cells of electrically small resonators are designed to operate at various predetermined range of frequencies.

5. The device of claim 1 wherein a plurality of said unit-cells of electrically small resonators are stacked in one- or two- or three-dimensional periodic or nearly periodic or aperiodic array.

6. The device of claim 5 wherein the periodicity of said array controls the input impedance of said plurality of said unit-cells of electrically small resonators.

7. The device of claim 5 wherein the separation distance between said electrically small resonators in said array is electrically small.

8. The device of claim 5 wherein the separation distance between said electrically small resonators in said array can be adjusted to exploit element coupling that leads to enhancement in the frequency bandwidth.

9. The device of claim 1 wherein said device or each of said unit-cells of electrically small resonators are connected to a plurality of rectifier circuits or diodes to convert the AC power to DC power while operating in the receiving mode.

10. The device of claim 1 wherein each of said unit-cells of electrically small resonators comprises:
a dielectric material substrate; and
a conducting patch deposited or printed on one surface of said dielectric material substrate with a plurality of broken Loops etched off from said conducting patch; and
a plurality of common conductive connectors deposited or printed on the opposite surface of said dielectric material substrate.

11. The device of claim 10 wherein said plurality of common conductive connectors are planar or strip line or meander line metallization.

12. The device of claim 10 wherein each of said unit-cells of electrically small resonators further comprises a dielectric material superstrate covering said conducting patch.

13. The device of claim 10 wherein each of said unit-cells of electrically small resonators further comprises a conductive line passing through said dielectric material substrate to channel the electric current between said conducting patch and said plurality of common conducting connectors.

14. The device of claim 10 wherein the electric current developed on said conducting patch is channeled to said plurality of common conductive connectors through electromagnetic modal coupling.
